(19) United States
(12) Patent Application Publication
(10) Pub. No.: US 2014/0198789 A1
(43) Pub. Date: Jul. 17, 2014

(54) LOW LATENCY IN-LINE DATA COMPRESSION FOR PACKET TRANSMISSION SYSTEMS

(71) Applicant: LSI CORPORATION, Milpitas, CA (US)

(72) Inventors: Seong-Hwan Kim, Allentown, PA (US); Paulus C. Pouw, Austin, TX (US)

(73) Assignee: LSI Corporation, Milpitas, CA (US)

(21) Appl. No.: 13/739,083

(22) Filed: Jan. 11, 2013

(51) Int. Cl. H04L 29/06

(52) U.S. Cl. CPC H04L 69/04
USPC 370/392

(57) ABSTRACT

Deep packet inspection (DPI) techniques are utilized to provide data compression, particularly necessary in many bandwidth-limited communication systems. A separate processor is initially used within a transmission source to scan, in real time, a data packet stream and recognize repetitive patterns that are occurring in the data. The processor builds a dictionary (ruleset), storing the set, of repetitive patterns and defining a unique token ID to be associated with each pattern. Thereafter, the DPI engine uses this ruleset to recognize the repetitive data patterns and replace each relatively long data pattern with its short token ID, creating a compressed data packet.

### FIELD OF THE INVENTION

The invention relates to data transmission in packet-based transmission systems and, more particularly, to providing in-line, adaptive data compression using a deep packet inspection (DPI) process.

### BACKGROUND OF THE INVENTION

The communications bandwidth in conventional electronic component systems and networks is usually limited by the processing capabilities of the electronic systems, as well as the overall network characteristics. Some traditional attempts at addressing bandwidth limitations involve compression of the information included in a communication packet. Network equipment providers are continually pressed to increase the efficiency of their equipment to overcome these bandwidth limitations and provide improved compression techniques. The cost and hardware requirements to improve efficiency are significant. The typical solution requires a full “store and compression” approach, which requires large temporary storage for the stream until compression is completed, introducing unwanted delay into the system.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

The present invention relates to a method of creating data compression in a packet stream to be transmitted, the method comprising analyzing an initial sample of the packet stream to identify data patterns, building a dictionary of identified data patterns and associating a unique token ID with each identified data pattern, creating a ruleset based on the dictionary, providing the ruleset to a deep packet inspection engine and directing the remainder of the packet stream through the deep packet inspection engine to scan and recognize data patterns from the ruleset, replacing each recognized data pattern with its associated token ID and identifying a start offset within the packet stream where the recognized data pattern was removed.

Additional embodiments of the invention are described in the remainder of the application, including the claims.

### BRIEF DESCRIPTION OF THE DRAWINGS

Embodiments of the present invention will become apparent from the following detailed description, the appended claims, and the accompanying drawings in which like reference numerals identify similar or identical elements.

FIG. 1 is a simplified diagram of a data compression system using DPI techniques in accordance with an embodiment of the present invention;

FIG. 2 is an exemplary ruleset as created by a processor in the system of FIG. 1;

FIG. 3 is a diagram comparing an “original” data packet to a “compressed” data packet as formed by a system formed in accordance with an embodiment of the present invention;

FIG. 4 is a flowchart illustrating an exemplary process for implementing the compression technique of one embodiment of the present invention;

FIG. 5 is a flowchart of an additional process for monitoring the compression ratio achieved using the methodology of an exemplary embodiment of the present invention;

FIG. 6 illustrates a simplified compression and decompression of a packet stream using a ruleset created in accordance with an exemplary embodiment of the inventive process; and

FIG. 7 illustrates an alternative data compression embodiment of the present invention when an identified data pattern is bridged between a pair of packets.

### DETAILED DESCRIPTION

Reference herein to “one embodiment” or “an embodiment” means that a particular feature, structure, or characteristic described in connection with the embodiment can be included in at least one embodiment of the invention. The appearances of the phrase “in one embodiment” in various places in the specification are not necessarily all referring to the same embodiment, nor are separate or alternative embodiments necessarily mutually exclusive of other embodiments. The same applies to the term “implementation”.

It should be understood that the steps of the exemplary methods set forth herein are not necessarily required to be performed in the order described, and the order of the steps of such methods should be understood to be merely exemplary. Likewise, additional steps might be included in such methods, and certain steps might be omitted or combined, in methods consistent with various embodiments of the present invention.

Also for purposes of this description, the terms “couple”, “coupling”, “coupled”, “connect”, “connecting”, or “connected” refer to any manner known in the art or later developed in which energy is allowed to be transferred between two or more elements, and the interposition Of one or more additional elements is contemplated, although not required. Conversely, the terms “directly coupled”, “directly connected”, etc., imply the absence of such additional elements. Signals and corresponding nodes or ports might be referred to by the same name and are interchangeable for purposes here. The term “or” should be interpreted as inclusive unless stated otherwise. Further, elements in a figure having subscripted reference numbers, (e.g. 100₁, 100₂, . . . 100_{K}) might be collectively referred to herein using the reference number 100.

Moreover, the terms “system,” “component,” “module,” “interface,” “model,” or the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

Deep packet inspection (DPI) is the process of identifying signatures (i.e., patterns or regular expressions) in the payload portion of a data packet. DPI is generally used as a security check to search for malicious types of internet traffic that can be buried in the data portion of the packet.

In accordance with one or more of the embodiments of the present invention, DPI techniques related to searching the payload portion of data packets are utilized to perform data compression, particularly necessary in many bandwidth-limited communication systems. A separate processor is initially used within a transmission source to scan, in real time, a data packet stream and recognize repetitive patterns that are occurring in the data. The processor builds a dictionary (ruleset), storing the set of repetitive patterns and defining a unique token identification (ID) to be associated with each pattern. Thereafter, the DPI engine uses this ruleset to recognize the repetitive data patterns in the packets being scanned, and replaces each relatively long data pattern with its short token ID, creating a stream of compressed data packets.

As long as the receiver of the compressed data stream has a dictionary of the same “data pattern-token ID” pairs as the original ruleset, the receiver will be able to re-create the initial data stream. The process as outlined below is able to work with long pattern lengths, replacing these long patterns with a relatively short token ID (e.g., 4 bytes, with additional bytes used to identify insertion location (i.e., “start” position) in the data stream).

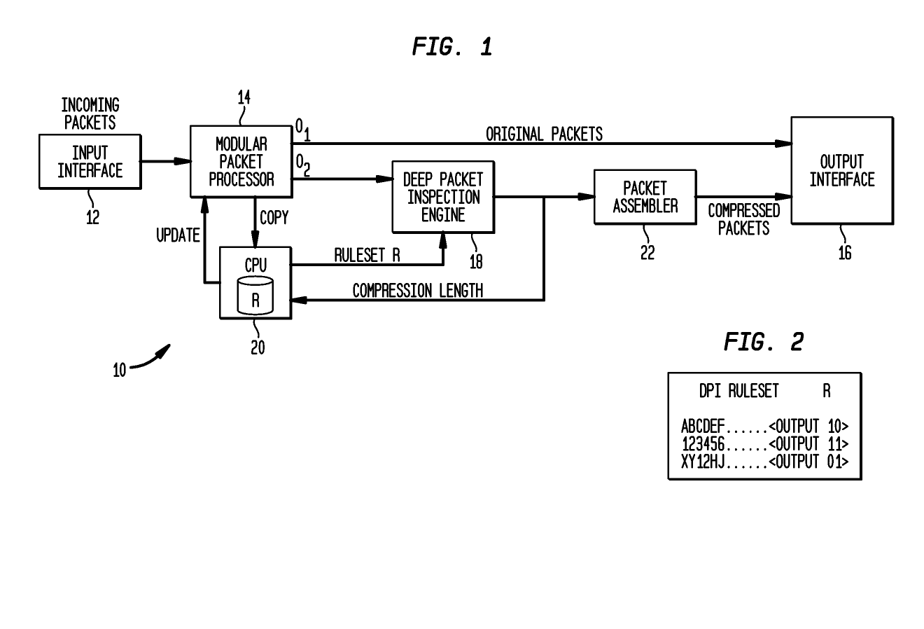

FIG. 1 is a diagram of an exemplary data compression system 10, illustrating the utilization of a DPI engine to perform data pattern recognition and compression in accordance with an exemplary embodiment of the present invention. An incoming packet is accepted via an input interface 12 (e.g., an Ethernet input/output adapter (EIOA) module) and is passed into a suitable data input processing module, such as a modular packet processor (MPP) 14. MPP 14 ma be configured as a special-purpose processor or a suitably programmed general purpose processor, as desired.

In accordance with this illustrated embodiment of the present invention, MPP 14 is used to determine if the particular type of data stream being prepared for transmission is an appropriate candidate for data compression (i.e., is it a data stream that is likely to include repetitive patterns or sequences, such as email). It is also possible to employ a user-configurable option to define specific data flows that need compression. Two different output paths from MPP 14 are shown, where first output path O₁ is shown as directly coupled to an output interface adapter 16. The data traffic that does not require data compression is directed onto this signal path and is thereafter prepared in output interface adapter 16 for transmission into the communication network (not shown).

Alternatively, if MPP 14 determines that the current packet stream is suitable for compression, the packets will be directed along a second output path O₂ as shown, where this traffic is then applied as an input to a DPI engine 18. As shown in FIG. 1, MPP 14 also functions to send a copy of an initial portion of this data stream to a central processing unit (CPU) 20. CPU 20 performs a pattern recognition process on the data, using an algorithm suitable for recognizing long patterns within a data stream. Coding algorithms such as Ziv-Lempel or Huffman may be used for this purpose, but should be considered as exemplary choices only.

CPU 20 then creates a ruleset R for use by DPI engine 18, the rule set including both the identified data patterns and a set of unique token IDs which CPU 20 assigns to the data patterns in a one-to-one relationship. An exemplary dictionary showing this ruleset R is shown in FIG. 2. CPU 20 sends a copy of ruleset R to both DPI engine 18 and the designated receiver(s) of this data stream, the latter copy sent into the network through the output interface adapter 16.

With this ruleset in place, DPI engine 18 scans the incoming packets for data patterns as defined by ruleset R. When found, DPI engine 18 reports pattern's token ID and location in the packet, with MPP 14 (or another module, such as a packet assembly engine) then removing this section of data and replacing it with the appropriate unique token ID and start location of the long data pattern. It is to be understood that DPI engine 18 will continue to perform, in parallel, its conventional function of scanning the payload portion of data packets for malicious program data while performing this data compression operation.

Once DPI engine 18 reaches the end of a particular packet, the set of token IDs and start locations are grouped together and added to the compressed packet (either at the beginning or end of the packet header) within a packet assembler 22. Once properly ordered, the final compressed packet is sent to output interface 16 for transmission across the communication network to the designated receiving location.

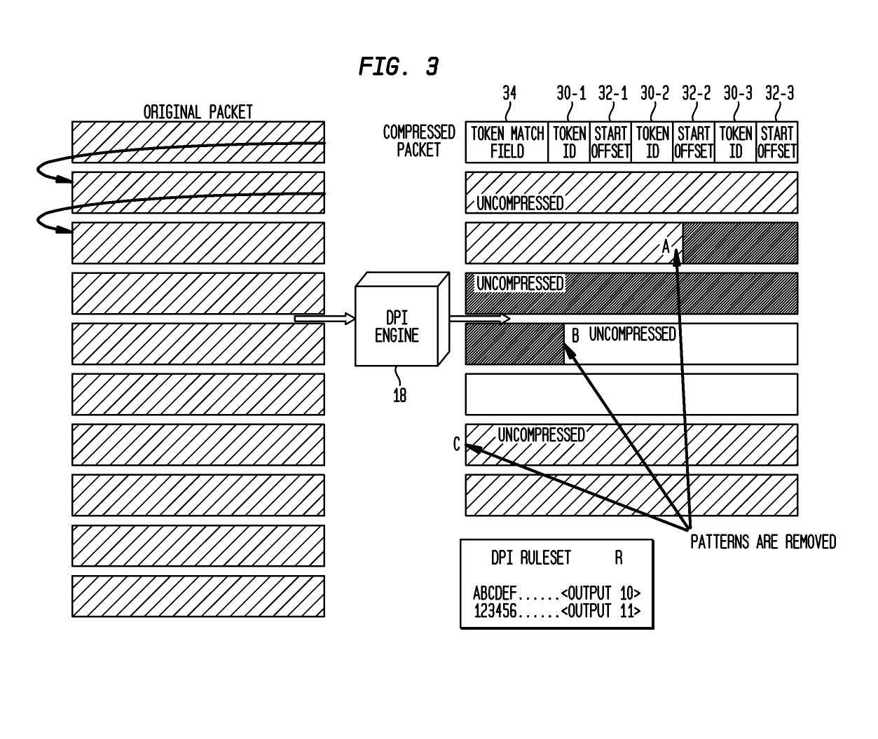

FIG. 3 is a diagram depicting the compression as performed by a DPI engine (perhaps in combination with other packet assembly or editing engines) on an exemplary original packet. The original packet is shown on the left-hand side of FIG. 3, where it is to be understood that as the packet “flows”, the end of the first line is immediately followed by the beginning of the second line, as indicated by the arrows. The illustration of the original packet as a column of packet sections is for the sake of clarity only.

The compressed packet output from DPI engine 18 is shown on the right-hand side of FIG. 3. In this particular arrangement, the results of the compression (i.e., token IDs and start locations) are pre-pended onto the packet header. A module such as packet assembler 22 is used to pre-pend this information only the compressed data portion of the packet. As shown in this example, DPI engine 18 has created a set of token IDs 30, as well as a set of “start offset” markers 32, that indicates the specific locations within the packet where the associated token is to be replaced by the original data pattern. For the sake of simplicity, it will be presumed that the processor has identified two patterns, as shown in the DPI ruleset of FIG. 3. Obviously, in an actual implementation, a DPI ruleset may contain tens to hundreds of identified patterns.

Referring to FIG. 3, each token ID 30 is linked with a start offset 32 in a one-to-one manner, where start offset 32-1 indicates that the pattern associated with token ID 30-1 was taken from location A in the original packet. Similarly, start offset 32-2 defines a location B where an original data pattern (as defined by token ID 30-2) was removed. Also included in the pre-pended information is a token match field 34. Token match field 34 is used to define the total number of matched tokens in the compressed packet. Since the length of the pre-pended header varies as a function of the number of pattern matches, token match field 34 is used to allow for the receive end to know the length of the current pre-pended header. With this header information and a copy of the DPI ruleset, a receiver is able to reconstruct the original packet from the compressed version.

As will be discussed below with an alternative embodiment of the present invention, the in-line compression arrangement may also perform a comparison of the length of the original packet to the compressed packet to define the “compression ratio” that is achieved by using the DPI pattern replacement process. The compression ratio is considered to be a measure of the efficiency of the compression process. An embodiment of the present invention allows for periodic monitoring of the compression ratio, providing the capability to recalculate the ruleset in an adaptive fashion.

Over time, it is possible that the initial data patterns identified by CPU 20 have become “outdated”, while newer patterns are not being recognized and, therefore, the compression process becomes inefficient. Thus, in an alternative embodiment of the present invention, CPU 20 receives feedback information from DPI engine 18 in terms of the current length of the compressed data traffic. CPU 20 uses this information to monitor the compression ratio on a periodic basis (the compression ratio defined as a ratio of the length compressed data stream to the length of the “original” data stream and sends an “update” signal to MPP 14 when the compression ratio becomes too high (i.e., approaches the value of “1”). In response to this update request, MPP 14 sends a current portion of the data stream to CPU 20, which performs the same pattern recognition analysis to generate a new, updated ruleset (sent to both DPI 18 and the receiver). During the period of time that CPU 20 is performing this update, MPP 14 is instructed to send all of the traffic through output O₁, so that the ruleset for DPI engine 18 can be updated without interruption.

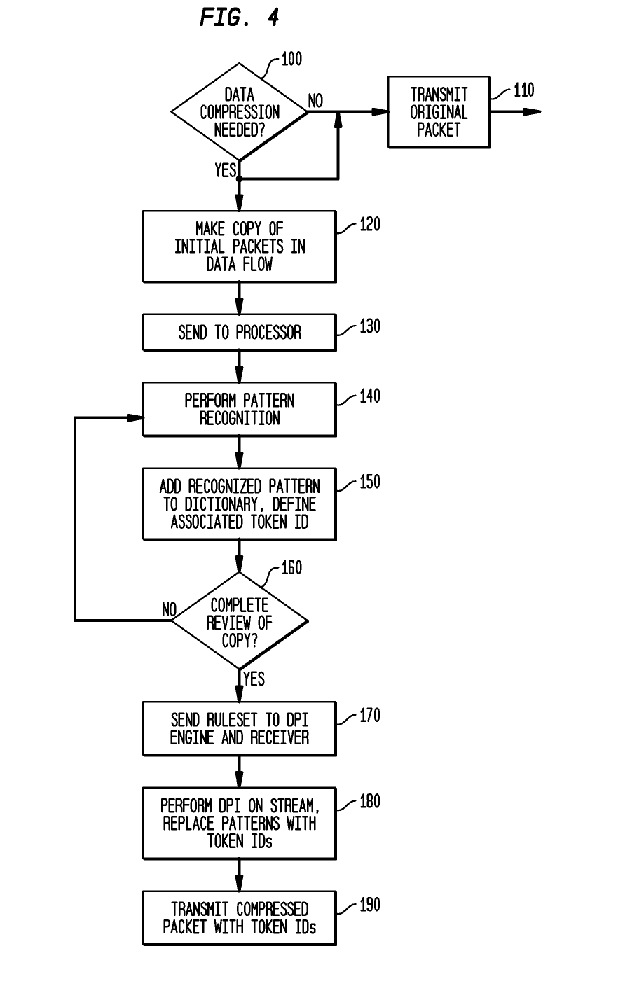

FIG. 4 contains a flow chart outlining an exemplary process of performing in-line compression on a data stream utilizing an exemplary arrangement of the present invention as described above. The process begins with making an initial determination of the value of performing compression on the current stream being transmitted. There are a variety of types of data streams where patterns occur so infrequently that the implementation of the techniques of the present invention are not warranted. However, there are also many types of transmitted streams that contain repetitive patterns and in most cases the transmitter can make a valid initial determination of the efficacy of data compression based on the type of data being transmitted.

In one embodiment of the present invention, a modular packet processor within a communication processor is used for identifying the packet type. This “type” information can then be used to make a determination regarding whether or not data compression would be appropriate. For example, email is known to be replete with patterns, particularly in an email “chain” where portions are copied multiple times within the body of the email. Thus, when the MPP recognizes a current data flow as being an email transmission, this data flow would be directed into the data compression process as described in detail below. As mentioned above, a user-configurable flag can be used to identify a data flow to be sent through a compression process.

Referring now to the particulars of the flow chart of FIG. 4, one exemplary process begins at step 100 by making the determination of whether or not, the current data flow should be compressed (step 100). If the answer is “no”, the data flow is then sent over the channel to its receiver in its original, uncompressed form (step 110). If the answer is “yes”, the process continues to step 120 to begin the compression analysis by first making a copy of an initial portion of the flow. As shown in FIG. 4, the original data stream is also sent to step 110 so that transmission of the initial data flow will begin, albeit in uncompressed form. Initiating the data flow without waiting for the compression analysis to be completed on the “copy” of the first data packets results in the system of the present invention exhibiting a lower latency than other compression techniques as previously used in such communication systems, which would “store” the first data packets and only send once the compression process was completed.

Returning to step 120, the compression process continues by sending the copy of the initial flow to a processor (step 130) which employs a predetermined algorithm to detect patterns in the data bits forming the stream (step 140). Coding algorithms such as Ziv-Lempel or Huffman may be used for this purpose, but should be considered as exemplary choices only. As the processor recognizes patterns, it builds a ruleset (step 150), creating linked pairs of the recognized pattern and a unique token ID.

The process continues searching until the entire copied portion of the data stream has been evaluated (step 160). At this point, the initial ruleset is defined as “complete”, containing a set of recognized data patterns, with a unique token ID being assigned to each data pattern. As shown in the flowchart of FIG. 4, the process then progresses by sending a copy of the ruleset to both the associated DPI engine and a designated receiving end of the data stream (step 170). Going forward, therefore, the DPI engine will scan the payload portion of incoming packets to look for the patterns as defined by the ruleset (step 180), replacing recognized patterns with their proper token IDs as defined in the ruleset (as well as their specific “start” locations within the packet). Once the packet has been completely scanned by the DPI engine, the results of the compression are pre-pended or appended on the packet header, and the compressed packet is transmitted over the data channel to the receiver (step 190). As described above, a token match field is included which the compression results so that the receive end will know the length of the current pre-pended header.

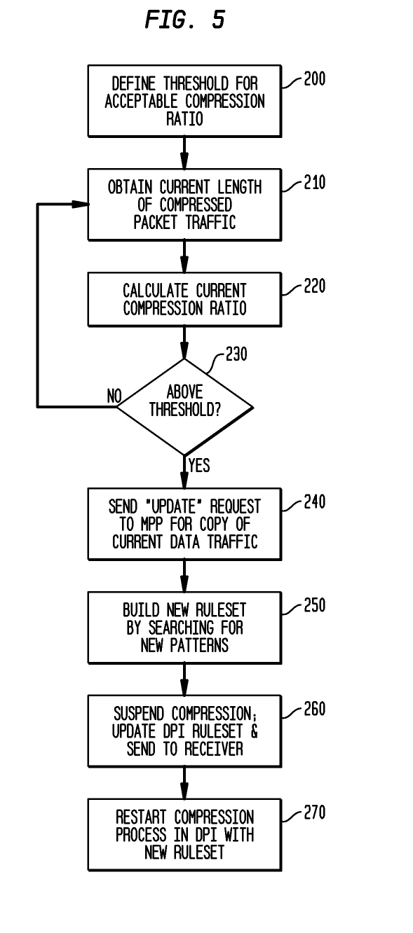

In an alternative embodiment of the present invention, the processor also monitors the compression ratio on a periodic basis to evaluate the efficiency of the compression process on an on-going basis. FIG. 5 illustrates an exemplary process flow within the processor that may be used for this data pattern monitoring and updating purpose. In this case, the process begins at step 200 with defining a compression ratio threshold value that is satisfactory for the particular circumstances. A variety of factors may be analyzed and used to determine an acceptable compression ratio threshold, including but not limited to, the bandwidth of the data channel, the transmission rate of the data signal, the quality of service (QoS) of the particular traffic type and the like. In a worst case situation, the compression ratio would be unity, indicating that no compression is taking place in the current data stream.

With an established threshold value, the process of FIG. 5 continues at step 210 with the processor retrieving information from the DPI engine including the original length of current packet being transmitted and the associated length of the compressed packet as created by the DPI engine. The processor then calculates the current compression ratio from these values (step 220) and compares it to the predefined threshold value (step 230). As long as the current value of the compression ratio remains below the threshold value, the compression process will continue unchanged and the processor will return to step 210 to monitoring the compression ratio associated with a newly-arriving packet.

On the other hand, if the result of the comparison of step 230 is that the current compression ratio has gone above the threshold value, the process moves to request the modular packet processor to send a current portion of the incoming data stream to the central processing unit (step 240). At this point, the central processing unit re-initiates the pattern recognition process as described above in association with the flowchart of FIG. 4 and develops an updated ruleset (step 250).

Once the new ruleset is completed, the process as shown in FIG. 5 continues by instructing the modular packet processor to stop passing the data flow through the DPI engine while the new ruleset is being installed (step 260), as discussed above in association with the discussion of system 10 of FIG. 1. Thus, for a short period of time, uncompressed traffic may flow. At this time, the new ruleset is also sent to the receiver. Once the new rulesets are in place, the compression process is re-initiated (step 270), with the incoming data flow directed into the DPI engine. This adaptive process is utilized to ensure that compression process maintains a desired level of efficiency in an environment where the specific data patterns will be changing over time.

The process involved at the receiving end of the data flow to reassemble the data packet from the compressed version is rather straightforward. The receiver extracts the token match field from the header, where as mentioned, above this header includes the total number of patterns that need to be re-inserted. The assembler then replaces each token ID with its associated data pattern, as extracted from the current version of the ruleset. The start offset value indicates to the receiver the proper location to insert the associated data pattern.

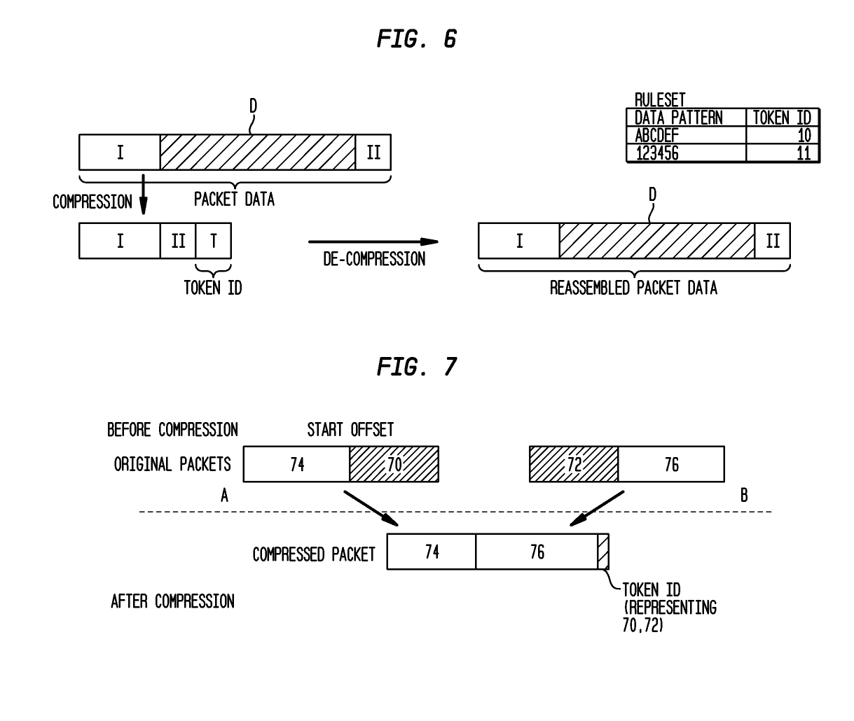

FIG. 6 illustrates an exemplary reassembly of a data packet from a received, compressed version. The compressed portion is shown on the left-hand side of FIG. 6, where a recognized data pattern D is removed from an original stream and replaced with a token ID T. The compressed packet thus comprises original data portions I and II, followed by a token ID T, which is associated with the long data pattern D. At the receiver, decompression occurs by using the same ruleset R, and a processor at the receiver looking up the token ID T, and retrieving the data pattern D associated with this token ID, and re-inserting data pattern D at the proper “start offset” S as included within the compressed packet.

It is also possible in an alternative embodiment of the present invention to provide inter-packet compression. This will occur when the DPI engine recognizes a pattern that begins in one packet and ends in the following packet. This possibility is illustrated in FIG. 7, where a recognized data pattern is shown as bridging between section 70 of packet A and section 72 of packet B. In this case, the compression results in transmitting original sections 74 and 76 from packets A and B, respectively, and replacing the data pattern defined by sections 70 and 72 with the proper token ID (and associated start offset).

Various arrangements of the present invention may be embodied in the form of methods and apparatuses for practicing those methods. Indeed, components and elements as used in one or more embodiments of the present invention may be embodied in the form of program code, for example, whether stored in a storage medium, loaded into and/or executed by a machine, or transmitted over some transmission medium or carrier, such as over electrical wiring or cabling, through fiber optics, or via electromagnetic radiation, wherein, when the program code is loaded into and executed by a machine, such as a computer, the machine becomes an apparatus for practicing the invention. When implemented on a general-purpose processor, the program code segments combine with the processor to provide a unique device that operates analogously to specific logic circuits.

The present invention can also be embodied in the form of a bitstream or other sequence of signal values electrically or optically transmitted through a medium, stored magnetic-field variations in a magnetic recording medium, etc., generated using a method and/or an apparatus of the present invention.

It will be further understood that various changes in the details, materials, and arrangements of the parts which have been described and illustrated in order to explain the nature of this invention may be made by those skilled in the art without departing from the scope of the invention as expressed in the following claims.

What is claimed is:

1. A method of creating data compression in a stream of data packets, the method comprising
analyzing an initial sample of the packet stream to identify data patterns;
creating a ruleset of identified data patterns and associating a unique token identification (ID) with each identified data pattern;
providing the ruleset to a deep packet inspection engine;
directing the stream of data packets through the deep packet inspection engine;
scanning each packet in the deep packet inspection engine to recognize data patterns based on the provided ruleset;
removing each recognized data pattern and replacing it with an associated token ID from the provided ruleset and information defining a location within the packet stream where the recognized data pattern was removed, to create a compressed packet.

2. The method as defined in claim 1 wherein the method further comprises the step of determining a current compression ratio defined as a ratio of a length of an original packet to a length of a compressed version of the original packet.

3. The method as defined in claim 2 wherein the method further comprises updating the ruleset by
defining a compression ratio threshold;
comparing the current compression ratio to the compression ratio threshold and, if above the defined threshold,
performing an update of the ruleset based upon a new sample from the stream of data packets.

4. The method as defined in claim 3 wherein the data compression process continues as an adaptive process by periodically comparing the current compression ratio to the defined threshold and updating the ruleset as needed.

5. The method as defined in claim 3 wherein during the step of performing the update of the ruleset, compression of the current stream of data packets is suspended.

6. The method as defined in claim 1 wherein the method further comprises preparing the compressed packet for transmission by adding each created token ID and associated location information to a header portion of the compressed packet.

7. The method as defined in claim 6 wherein a token match field definition is further added to the header portion of the compressed packet, the token match field defining the total number of token IDs added to the header portion of the compressed packet.

8. A system for performing in-line compression, of data in a packet transmission system, the system comprising
a processor for implementing a pattern recognition algorithm to identify data patterns in a stream of data packets, the processor configured to create a ruleset of the identified data patterns and associate a unique token identifications (ID) with each identified data pattern; and
a deep packet inspection engine, responsive to the stream of packet data and the created ruleset for scanning the data portion of each packet, the deep packet inspection engine configured to recognize patterns from the ruleset and replace the patterns with the proper token identifications (IDs) and information defining a location within the packet stream where the recognized data pattern was removed, to create a compressed packet.

9. The system as defined in claim 8 wherein the processor is configured to utilize a suitable coding algorithm to identify data patterns.

10. The system as defined in claim 9 wherein the processor is configured to utilize a Ziv-Lempel or Huffman coding algorithm as a suitable algorithm to identify data patterns.

11. The system as defined in claim 8 wherein the system further comprises
a data input processing module configured to analyze an incoming stream of data and make a determination on the need to perform data compression on the incoming stream, the data processing device further configured to send a copy of an initial portion of any stream identified for compression to the processor, the processor performing pattern recognition on the initial portion of the supplied stream, the data input processing device also configured to direct the incoming stream of data into the deep packet inspection engine.

12. The system as defined in claim 11 wherein a user-configurable flag is included as an arrangement for identifying an incoming stream that requires compression.

13. The system as defined in claim 11 wherein the data input processing module makes a compression determination based upon information defining a type of data included in the incoming stream of data packets.

14. The system as defined in claim 8 wherein the processor receives an input from the deep packet inspection engine defining a current length of a compressed packet and uses this information to create a compression ratio of the original and current lengths, the processor configured to send an update signal to the input signal processing element to request a new copy of an initial portion of a data packet when the compression ratio goes above a predefined threshold.

15. The system as defined in claim 8 wherein the system further comprises
an assembler responsive to the output of the deep packet inspection engine and configured to order remaining portions of a data packet with the generated token IDs and location definitions to a header portion of the data packet, the assembler configured to transmit the final compressed packet after the token information is added.

16. The system as defined in claim 15 wherein the added information includes a token match field defining a total number of token IDs added to the header portion of the compressed packet.

17. The system as defined in claim 8 wherein the system further comprises
a receiver for collecting incoming, compressed packets, the receiver including
a processor for retrieving header information, including token ids and start locations from each incoming, compressed packet, the processor using the token IDs to retrieve the associated data patterns from a copy of the ruleset at the receiver and inserting the retrieved data patterns at the locations in the packet defined by the associated location information, re-creating an original packet from the compressed version thereof.

18. A method of utilizing data compression in a packet data transmission system, the method comprising the steps of:
analyzing an incoming stream of packet data and making a determination on the need to perform data compression on the incoming stream,
if no compression is required, preparing the original data stream for transmission, otherwise
analyzing an initial sample of the packet stream to identify data patterns;
creating a ruleset of identified data patterns and associating a unique token identification (ID) with each identified data pattern;
providing the ruleset to a deep packet inspection engine; and
directing the remainder of the stream of data packets through the deep packet inspection engine;
scanning each packet in the deep packet inspect engine to recognize data patterns based on the provided ruleset; and
removing each recognized data pattern and replacing it with an associated token ID and information, defining a location within the packet stream where the recognized data pattern was removed to create a compressed packet.

19. The method of claim 18 further comprising the steps of:
assembling each compressed packet to add each token ID and associated location information to a header portion of the associated packet; and
transmitting the compressed packets across a communication network to a designated receiver.

20. The method of claim 18 further comprising the steps of:
defining a compression ratio threshold;
comparing the current compression ratio to the compression ratio threshold and, if above the defined threshold,
performing an update of the ruleset based upon a new sample from the stream of data packets, wherein the data compression process continues as an adaptive process by periodically comparing the current compression ratio to the defined threshold and updating the ruleset as needed.
